(19) United States
(12) Patent Application Publication
(10) Pub. No.: US 2014/0204089 A1
(43) Pub. Date: Jul. 24, 2014

(54) METHOD AND APPARATUS FOR CREATING THREE-DIMENSIONAL MONTAGE

(71) Applicant: Electronics and Telecommunications Research Institute, Daejeon (KR)

(72) Inventors: Seong Jae LIM, Daejeon (KR); Kap Kee KIM, Daejeon (KR); Seung Uk YOON, Bucheon (KR); Bon Woo HWANG, Daejeon (KR); Hye Ryeong JUN, Daejeon (KR); Jin Sung CHOI, Daejeon (KR); Bon Ki KOO, Daejeon (KR)

(21) Appl. No.: 14/157,636

(22) Filed: Jan. 17, 2014

(30) Foreign Application Priority Data
Jan. 18, 2013 (KR) 10-2013-0005703

(51) Int. Cl. G06T 15/08

(52) U.S. Cl. CPC G06T 15/08
USPC 345/427

(57) ABSTRACT

Disclosed is a method and apparatus for creating a three-dimensional (3D) montage. The apparatus for creating a 3D montage may include an image information extraction unit to extract image information from a face image to be reconstructed, using a face area based on statistical feature information and a feature vector, a 3D unique face reconstruction unit to reconstruct a 3D unique face model by fitting a 3D standard face model to face images of each view for the face image and feature information of each part for the face area, a 3D montage model generation unit to generate a 3D montage model by combining the reconstructed 3D unique face model with 3D face expression model information and 3D decoration model information, and a montage image generation unit to generate a montage image by projecting the generated 3D montage model from each view.

### CROSS-REFERENCE TO RELATED APPLICATION(S)

This application claims the benefit under 35 U.S.C. §119(a) of Korean Patent Application No. 10-2013-0005703, filed on Jan. 18, 2013, in the Korean Intellectual Property Office, the entire disclosure of which is incorporated herein by reference for all purposes.

### BACKGROUND

1. Field

Exemplary embodiments relate to a method and apparatus for creating a three-dimensional (3D) montage, and more particularly, to a method and apparatus for creating a 3D montage that may create a 3D montage by reconstructing a 3D facial appearance using face images of each view obtained from different types of sensors and combining the 3D facial appearance with color, expression, and decoration models.

2. Description of Related Art

A conventional method of creating a montage involves making a two-dimensional (2D) sketch based on depiction of a witness or combining partial shapes of a face. Recently, with the introduction of a method of creating a three-dimensional (3D) montage, a 3D montage is created by compositing or morphing particular area information of a face and partial shapes from a 3D partial face shape database (DB).

In this instance, to creating a 3D montage, a 3D montage face model is generally generated using a scanning technique in which invariant appearance information of an object is scanned with an active sensor using laser or patterned light. Also, the 3D montage face model is generated using a multi-view image, a stereo image, or a sensor-based technique, for example, a depth sensor, depending on a preset condition. In this instance, the preset condition may include illumination, sensor geometric information, a viewpoint, and the like. Also, the 3D montage face model is generated manually by a skilled expert.

However, the scanning technique requires post-processing by an expert. Also, the sensor-based technique produces a desired result only under the preset condition. Further, with the recent widespread of a closed-circuit television (CCTV) and various types of sensors, suspect images of various non-preset angles and types are obtained from a plurality of cameras, and as a result, the sensor-based technique encounters issues in terms of synchronization between the cameras, color consistency, geometric calibration, and the like.

### SUMMARY

The foregoing and/or other aspects are achieved by providing a method and apparatus for creating a three-dimensional (3D) montage that may generate a multi-view 3D montage model using images obtained from different types of sensors, thereby minimizing issues in terms of synchronization between the different types of sensors, color consistency, geometric calibration, and the like.

The foregoing and/or other aspects are achieved by providing a method and apparatus for creating a 3D montage that may compare images obtained by projecting a 3D montage model at various angles and in various sizes to an image from a security sensor, thereby tracking a location and a behavior of a suspect in real time.

In one general aspect, there is provided an apparatus for creating a 3D montage, including an image information extraction unit to extract image information from a face image to be reconstructed using a face area based on statistical feature information and a feature vector, a 3D unique face reconstruction unit to reconstruct a 3D unique face model by fitting a 3D standard face model to face images of each view for the face image and feature information of each part for the face area, a 3D montage model generation unit to generate a 3D montage model by combining the reconstructed 3D unique face model with 3D face expression model information and 3D decoration model information, and a montage image generation unit to generate a montage image by projecting the generated 3D montage model from each view.

The image information extraction unit may detect the feature vector of the face area using a statistical feature of the statistical feature information.

The image information extraction unit may arrange the face images by view using at least one of an angle, a view, and a scale of the feature vector.

The image information extraction unit may collect face image information of a front view among the arranged face images, and may extract image information for generating a texture map.

The 3D unique face reconstruction unit may select the 3D standard face model based on silhouette information of a particular view in the images of each view and the feature information of each part.

The 3D unique face reconstruction unit may perform global fitting of the 3D standard face model to silhouette information of a particular view in the images of each view and the feature information of each part.

The 3D unique face reconstruction unit may modify a shape of the 3D standard face model by performing global fitting of the fitted 3D standard face model to the silhouette information of the images of each view and the feature information of each part, using the fitted 3D standard face model and the silhouette information as a guide line.

The 3D unique face reconstruction unit may reconstruct the 3D unique face model corresponding to the modified 3D standard face model using a texture map generated based on the image information.

The 3D montage generation unit may generate the 3D montage model by combining the 3D unique face model with a face expression model and a decoration model that are probabilistically likely to be used for disguise.

In another general aspect, there is provided a method of creating a 3D montage, including extracting image information from a face image to be reconstructed using a face area based on statistical feature information and a feature vector, reconstructing a 3D unique face model by fitting a 3D standard face model to face images of each view for the face image and feature information of each part for the face area, generating a 3D montage model by combining the reconstructed 3D unique face model with 3D face expression model information and 3D decoration model information, and generating a montage image by projecting the generated 3D montage model from each view.

The extracting of the image information may include detecting the feature vector of the face area using a statistical feature of the statistical feature information.

The extracting of the image information may include arranging the face images by view using at least one of an angle, a view, and a scale of the feature vector.

The extracting of the image information may include collecting face image information of a front view among the arranged face images and extracting image information for generating a texture map.

The reconstructing of the 3D unique face model may include selecting the 3D standard face model based on silhouette information of a particular view in the images of each view and the feature information of each part.

The reconstructing of the 3D unique face model may include performing global fitting of the 3D standard face model to silhouette information of a particular view in the images of each view and the feature information of each part.

The reconstructing of the 3D unique face model may include modifying a shape of the 3D standard face model by performing global fitting of the fitted 3D standard face model to silhouette information of the images of each view and the feature information of each part, using the fitted 3D standard face model and the silhouette information as a guide line.

The reconstructing of the 3D unique face model may include reconstructing the 3D unique face model corresponding to the modified 3D standard face model using a texture map generated based on the image information.

The generating of the 3D montage image may include generating the 3D montage model by combining the 3D unique face model with a face expression model and a decoration model that are probabilistically likely to be used for disguise.

Other features and aspects will be apparent from the following detailed description, the drawings, and the claims.

### BRIEF DESCRIPTION OF THE DRAWINGS

FIG. 1 is a diagram illustrating an apparatus for creating a three-dimensional (3D) montage according to an embodiment.

FIG. 2 is a diagram illustrating a detailed configuration of an apparatus for creating a 3D montage according to an embodiment.

FIG. 3 is a diagram illustrating a configuration of actual implementation of an apparatus for creating a 3D montage according to an embodiment.

FIG. 4 is a diagram illustrating an image information extraction unit according to an embodiment.

FIG. 5 is a diagram illustrating a 3D unique face reconstruction unit according to an embodiment.

FIG. 6 is a diagram illustrating a 3D montage model generation unit according to an embodiment.

FIG. 7 is a diagram illustrating a montage image generation unit according to an embodiment.

FIG. 8 is a diagram illustrating a method of creating a 3D montage according to an embodiment.

FIG. 9 is a diagram illustrating a standard face mesh model according to an embodiment.

FIG. 10 is a diagram illustrating modeling of a 3D standard face model into a parametrically controllable Non-Uniform Rational B-Spline (NURBS) curve according to an embodiment.

FIG. 11 is a diagram illustrating a process of binding a skin vertex of a 3D standard mesh model to a NURBS curve according to an embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

Hereinafter, exemplary embodiments of the present invention are described in detail with reference to the accompanying drawings.

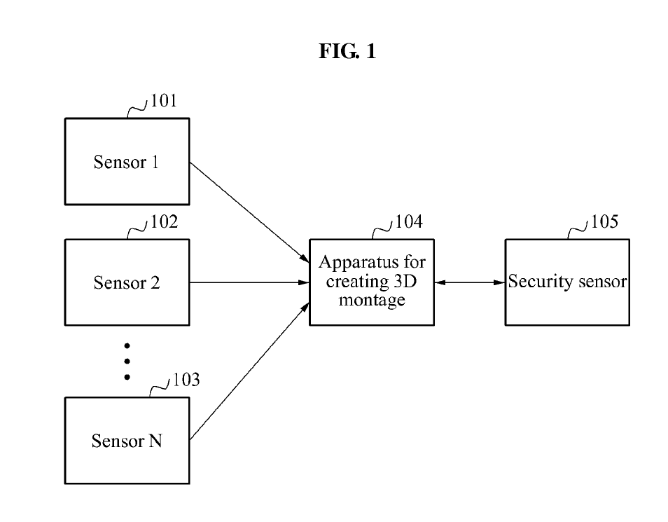

FIG. 1 is a diagram illustrating an apparatus 104 for creating a three-dimensional (3D) montage according to an embodiment.

Referring to FIG. 1, the apparatus 104 for creating a 3D montage may receive an input of images from a sensor 1 101, a sensor 2 102, and a sensor N 103. In this instance, the sensor 1 101, the sensor 2 102, and the sensor N 103 may correspond to different types of sensors. That is, the sensor 1 101, the sensor 2 102, and the sensor N 103 may correspond to a sensor for obtaining images having various angles, types, views, and the like. For example, the sensor 1 101, the sensor 2 102, and the sensor N 103 may include a closed-circuit television (CCTV), a charge-coupled device (CCD) camera, a depth camera, a user terminal or user equipment (UE), and the like.

The apparatus 104 for creating a 3D montage may extract image information using the images of a face to be reconstructed, input from the sensor 1 101, the sensor 2 102, and the sensor N 103. More specifically, the apparatus 104 for creating a 3D montage may detect a face area based on statistical feature information from the images of the face to be reconstructed. The statistical feature information may correspond to a statistical feature, for example, color space information, geometric space information, and depth space information of the face area.

Also, the apparatus 104 for creating a 3D montage may generate a statistical feature vector using the statistical feature of the statistical feature information. The apparatus 104 for creating a 3D montage may arrange the face images by view using the statistical feature vector. The apparatus 104 for creating a 3D montage may collect face image information of a front view among the arranged face images. The apparatus 104 for creating a 3D montage may extract image information for generating a texture map using the collected face image information.

The apparatus 104 for creating a 3D montage may select a 3D standard face model corresponding to silhouette information of the face images of each view and feature information of each part. The apparatus 104 for creating a 3D montage may perform global fitting of the selected 3D standard face model to the silhouette information of the face images of each view and the feature information of each part. Also, the apparatus 104 for creating a 3D montage may modify a shape of the 3D standard face model by performing global fitting of the 3D standard face model. Also, the apparatus 104 for creating a 3D montage may generate a texture map based on the image information. The apparatus 104 for creating a 3D montage may reconstruct a 3D unique face model corresponding to the modified 3D standard face model using the generated texture map.

The apparatus 104 for creating a 3D montage may generate a 3D montage model by combining the 3D unique face model with an expression model and a decoration model that are likely to be used for disguise. Also, the apparatus 104 for creating a 3D montage may generate a montage image by projecting the generated 3D montage model at various angles. Also, the apparatus 104 for creating a 3D montage may track a location and a behavior of a suspect by comparing the generated montage image to an input image detected from a security sensor 105.

According to an exemplary embodiment, the apparatus for creating a 3D montage may generate a multi-view 3D montage model using images obtained from different types of sensors, thereby minimizing issues in terms of synchronization between different types of sensors, color consistency, geometric calibration, and the like.

Also, the apparatus and method for creating a 3D montage may compare images obtained by projecting a 3D montage model at various angles and in various sizes to an image from a security sensor, thereby tracking a location and a behavior of a suspect in real time.

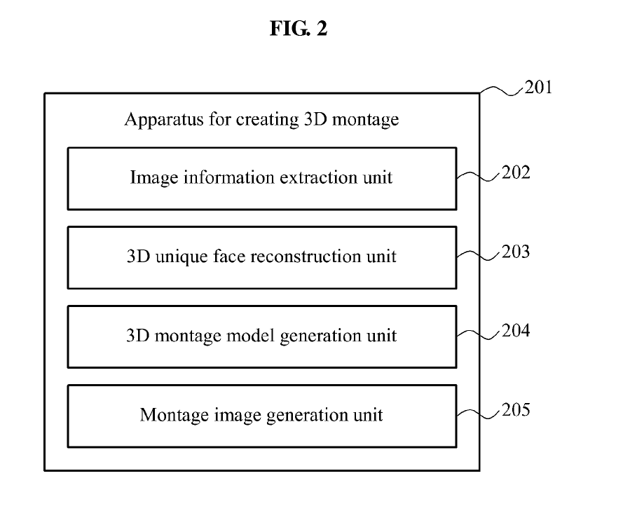

FIG. 2 is a diagram illustrating a detailed configuration of an apparatus 201 for creating a 3D montage according to an embodiment.

Referring to FIG. 2, the apparatus 201 for creating a 3D montage may include an image information extraction unit 202, a 3D unique face reconstruction unit 203, a 3D montage model generation unit 204, and a montage image generation unit 205.

The image information extraction unit 202 may receive an input of images of a face to be detected from different types of sensors. The image information extraction unit 202 may detect a face area using the input face images. In this instance, the image information extraction unit 202 may detect the face area based on statistical feature information. The statistical feature information may correspond to a statistical feature, for example, color space information, geometric space information, and depth space information of the face area.

The image information extraction unit 202 may generate a statistical feature vector using the statistical feature. The image information extraction unit 202 may arrange the face images corresponding to the detected face area by view. Specifically, the image information extraction unit 202 may calculate a face angle, a view, and a scale of the face area based on the statistical feature vector. Also, the image information extraction unit 202 may arrange the face images by view based on the calculated face angle, the calculated view, and the calculated scale of the face area. In this instance, the scale may be calculated through affine transform.

Also, the image information extraction unit 202 may collect face image information of a front view among the arranged face images, and may extract image information for generating a texture map. That is, the image information extraction unit 202 may collect face image information close to a front view, and may extract image information for generating a texture map. Also, the image information extraction unit 202 may store the extracted image information.

The 3D unique face reconstruction unit 203 may reconstruct a 3D unique face model by fitting a 3D standard face model to the arranged face images of each view for the face area and feature information of each part for the face area.

More specifically, the 3D unique face reconstruction unit 203 may extract silhouette information of a particular view in the face images of each view and feature information of each part for the face area. The 3D unique face reconstruction unit 203 may extract the feature information of each part at each skeleton location of the parts in the face area based on the silhouette information of the particular view. Also, the 3D unique face reconstruction unit 203 may extract a parameter, for example, a height and a width at each skeleton location of the parts. The 3D unique face reconstruction unit 203 may select a 3D standard face model based on the extracted parameter. That is, the 3D unique face reconstruction unit 203 may select the 3D standard face model corresponding to the extracted height and width of the 3D skeleton. In this instance, the 3D standard face model may correspond to a 3D standard face model DB based on the statistical feature information. That is, the 3D standard face model may correspond to a preset model based on the statistical feature information.

The 3D unique face reconstruction unit 203 may perform global fitting of the selected 3D standard face model based on the extracted parameter. The 3D unique face reconstruction unit 203 may set, as a guide line, the silhouette information of the particular view and shape information of the globally fitted 3D standard face model. Also, the 3D unique face reconstruction unit 203 may extract silhouette information of a different view in the face images, and may perform global fitting of the 3D standard face model. The 3D unique face reconstruction unit 203 may perform global fitting iteratively until the silhouette information of the particular view set as the guide line appears. The 3D unique face reconstruction unit 203 may modify a shape of the 3D standard face model by performing fitting iteratively. Also, the 3D unique face reconstruction unit 203 may generate a fitted 3D standard face model including multi-view face image information by performing global fitting iteratively. In this instance, the fitted 3D standard face model may correspond to a fitted 3D standard mesh model.

For example, the 3D unique face reconstruction unit 203 may extract silhouette information of a side view corresponding to the face area of the face image. Also, the 3D unique face reconstruction unit 203 may perform global fitting of the fitted 3D standard face model based on the silhouette information of the side view. Also, the 3D unique face reconstruction unit 203 may modify the shape of the 3D standard face model by performing fitting again.

Also, the 3D unique face reconstruction unit 203 may reconstruct the 3D unique face model by generating a texture map based on the image information for generating the texture map.

The 3D montage model generation unit 204 may generate a 3D montage model by combining the reconstructed 3D unique face model with 3D face expression model information and 3D decoration model information.

That is, the 3D montage model generation unit 204 may generate an expression of the 3D unique face model using the 3D face expression model information. In this instance, the 3D face expression model information may correspond to a statistical feature-based 3D face expression model DB. Also, the 3D montage model generation unit 204 may combine the 3D unique face model with various decoration models using the 3D decoration model information. In this instance, the 3D decoration model information may correspond to a DB for decorating the montage, and may include a mustache, a beard, a hair, glasses, a hat, a cap, accessories, and the like.

The 3D montage model generation unit 204 may generate the 3D montage model by combining an expression model and a decoration model that are probabilistically likely to be used. For example, the 3D montage model generation unit 204 may generate a shape of a face that a suspect is the most likely to disguise himself or herself, by adding a hair, a shape change of a mustache or a beard, glasses, and the like, to the generated 3D unique face model.

That is, the 3D montage model generation unit 204 may generate a probabilistically high 3D montage model using various expression models and various decoration models based on information associated with an appearance that a suspect is the most likely to disguise himself of herself.

The montage image generation unit 205 may generate a montage image by projecting the generated 3D montage model from each view. The montage image generation unit 205 may detect a face area in an input image from a security sensor. In this instance, the face area in the input image from the security sensor may be detected by real-time processing through matching a motion vector of a moving object to the generated montage image. The montage image generation unit 205 may compare the 3D montage model to the detected face area from the security sensor, and may conduct an analysis. Also, the montage image generation unit 205 may track a location and a behavior of the suspect in real time using a result of the analysis.

That is, the montage image generation unit 205 may detect and track the suspect by comparing and analyzing the generated montage image to the face area from the security sensor in real time.

The apparatus for generating a 3D montage may reconstruct the shape of the 3D unique face model without geometric calibration of face images from different types of sensors, by reconstructing the 3D unique face model using the face area based on the statistical feature information and the feature vector. Also, the apparatus for generating a 3D montage may generate 3D unique face models of various angles and sizes without geometric calibration of face images from different types of sensors, by adding various expressions and decorations to the 3D unique face model.

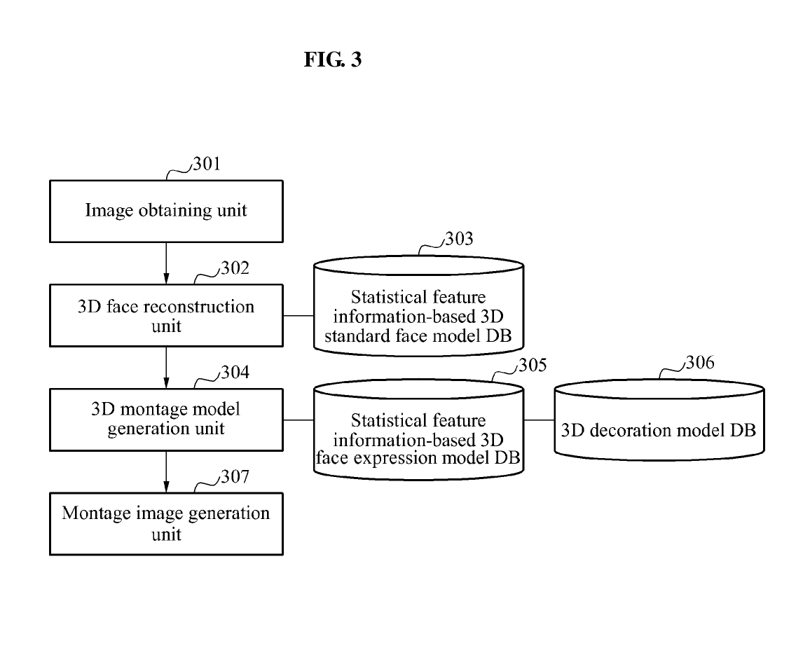

FIG. 3 is a diagram illustrating a configuration of actual implementation of an apparatus for creating a 3D montage according to an embodiment.

Referring to FIG. 3, an information obtaining unit 301 may extract a face area based on statistical feature information using input images of a face to be detected from different types of sensors. Also, the information obtaining unit 301 may correspond to the image information extraction unit 202 of FIG. 2. The information obtaining unit 301 may extract a statistical feature vector of the face area based on a statistical feature of the statistical feature information. That is, the information obtaining unit 301 may obtain the face area of the face image and the statistical feature information.

The information obtaining unit 301 may calculate a face angle, a view, a scale of the face area based on the statistical feature vector, and may arrange the face images by view. Also, the information obtaining unit 301 may collect face image information close to a front view among the arranged face images, and may extract image information for generating a texture map. Also, the information obtaining unit 301 may store the extracted image information.

A 3D face reconstruction unit 302 may correspond to the 3D unique face reconstruction unit 203 of FIG. 2. The 3D face reconstruction unit 302 may interwork with a statistical feature-based 3D standard face model DB 303. The statistical feature-based 3D standard face model DB 303 may include a parameter, for example, skeletons of the face area and a height and a width of each skeleton, based on the statistical feature information. Also, the 3D standard face model DB 303 may include a Non-Uniform Rational B-Spline (NURBS) curve to which different skeletons and skin vertices are bound based on the parameter.

The 3D face reconstruction unit 302 may extract silhouette information of a particular view in the face images of each view and feature information of each part for the face area. Also, the 3D face reconstruction unit 302 may compare the parameter, for example, skeleton locations of each part in the face area and a height and a width at each skeleton location, to the 3D standard model of the statistical feature-based 3D standard face model DB 303. The 3D face reconstruction unit 302 may select a 3D standard model corresponding to the parameter. The 3D standard model may correspond to a 3D standard face model.

The 3D face reconstruction unit 302 may perform global fitting based on the parameter by controlling a NURBS curve of the selected 3D standard model. The 3D face reconstruction unit 302 may modify and improve shape information of the 3D standard model by performing global fitting of the 3D standard model to the silhouette information of the particular view. The 3D face reconstruction unit 302 may perform global fitting of the face images iteratively until the initial silhouette information of the particular view appears. Also, the 3D face reconstruction unit 302 may generate a 3D unique mesh model covering a multi-view face image. The 3D unique mesh model may correspond to a globally fitted 3D standard model. Also, the 3D face reconstruction unit 302 may generate a 3D unique face model by generating a texture map based on the image information for generating the texture map.

A 3D montage model generation unit 304 may interwork with a statistical feature-based 3D face expression model DB 305 and a 3D decoration model DB 306. The statistical feature-based 3D face expression model DB 305 may include expressions that are probabilistically likely to be used for disguise. The 3D decoration model DB 306 may include information associated with a decoration, for example, a hair, a mustache, a beard, a shape change of a mustache or beard, glasses, a hat, a cap, accessories, and the like.

The 3D montage model generation unit 304 may generate various expressions by modifying the shape of the 3D unique face model based on the statistical feature-based 3D face expression model DB 305. Also, the 3D montage model generation unit 304 may combine the 3D unique face model with various decoration models based on the 3D decoration model DB 306.

The 3D montage model generation unit 304 may generate a 3D montage model by combining the 3D unique face model with an expression model and a decoration model that are probabilistically likely to be used.

A montage image generation unit 307 may generate a montage image by projecting the generated 3D montage model from each view, and may detect a face area in an input image from a security sensor. The montage image generation unit 307 may compare the 3D montage model to the face area detected from the security sensor, and may conduct an analysis. Also, the montage image generation unit 307 may track a location and a behavior of a suspect in real time using a result of the analysis.

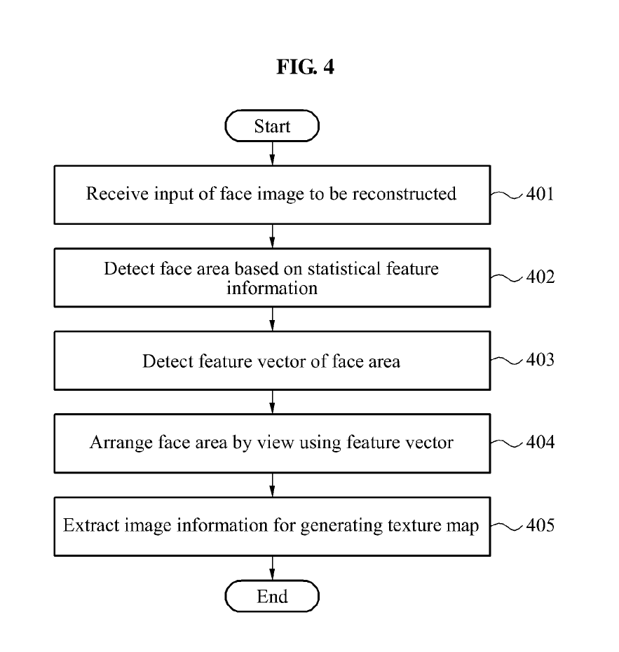

FIG. 4 is a diagram illustrating an image information extraction unit according to an embodiment.

Referring to FIG. 4, in 401, the image information extraction unit may receive an input of images of a face to be detected from different types of sensors. In this instance, the face images may differ in angles, types, views, scales, and the like.

In 402, the image information extraction unit may detect a face area in the images of the face to be reconstructed, based on statistical feature information. In this instance, the image information extraction unit may detect the face area using a statistical feature, for example, color space information, geometric space information, and depth space information of the face area.

In 403, the image information extraction unit may generate a statistical feature vector using the statistical feature of the statistical feature information. The statistical feature vector may correspond to a statistical feature vector of the face area.

In 404, the image information extraction unit may arrange the face images by view, using the detected statistical feature vector. Specifically, the image information extraction unit may calculate a face angle, a view, and a scale of the face area, and may arrange the face images by view.

In 405, the image information extraction unit may collect face image information of a front view among the arranged face images, and may extract image information for generating a texture map. Also, the image information extraction unit may store the extracted image information.

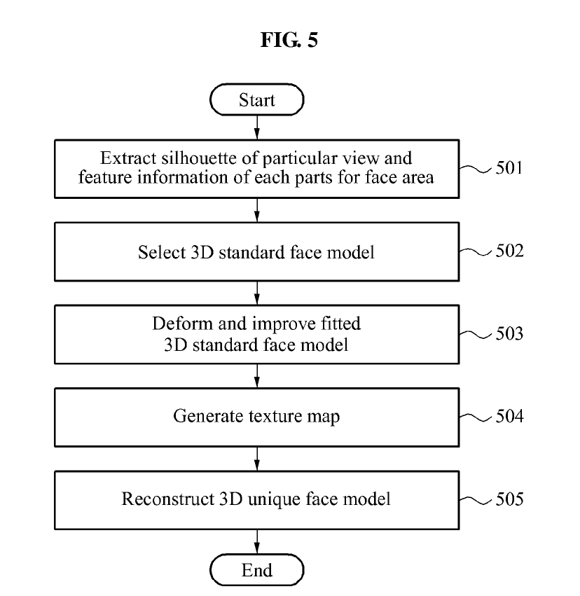

FIG. 5 is a diagram illustrating a 3D unique face reconstruction unit according to an embodiment.

Referring to FIG. 5, in 501, the 3D unique face reconstruction unit may extract silhouette information of a particular view in face images of each view and feature information of each part for a face area. The 3D unique face reconstruction unit may extract the feature information of each part in the face area at each skeleton location of the parts based on the silhouette information of the particular view. Also, the 3D unique face reconstruction unit may extract a parameter, for example, a height and a width at each skeleton location of the parts.

In 502, the 3D unique face reconstruction unit may select a 3D standard face model based on the extracted parameter. That is, the 3D unique face reconstruction unit may select the 3D standard face model corresponding to the extracted height and width of the 3D skeleton.

In 503, the 3D unique face reconstruction unit may perform global fitting of the selected 3D standard face model based on the extracted parameter. The 3D unique face reconstruction unit may set, as a guide line, the silhouette information of the particular view and shape information of the globally fitted 3D standard face model. Also, the 3D unique face reconstruction unit may extract silhouette information of a different view in the face images, and may perform global fitting of the 3D standard face model. The 3D unique face reconstruction unit may perform global fitting iteratively until the silhouette information of the particular view set as the guide line appears. The 3D unique face reconstruction unit may modify and improve the shape of the 3D standard face model by performing fitting iteratively. Also, the 3D unique face reconstruction unit may perform global fitting by controlling a NURBS curve to which skeletons and skin vertices of the selected 3D standard face model are bound.

Also, the 3D unique face reconstruction unit may generate a fitted 3D standard face model including multi-view face image information by performing global fitting iteratively. In this instance, the fitted 3D standard face model may correspond to a fitted 3D standard mesh model.

In 504, the 3D unique face reconstruction unit may generate a texture map based on image information for generating the texture map.

In 505, the 3D unique face reconstruction unit may reconstruct a 3D unique face model using the generated texture map.

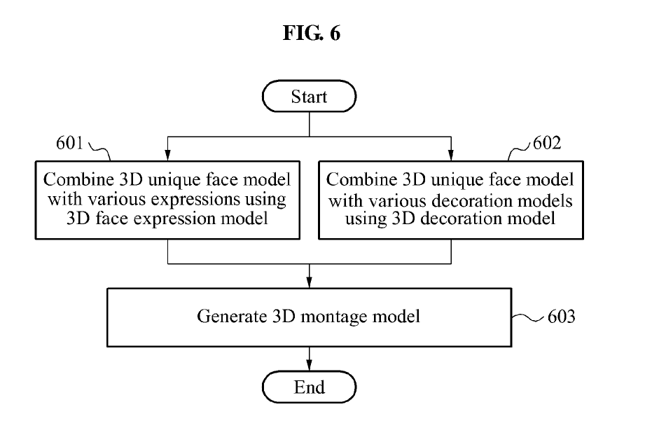

FIG. 6 is a diagram illustrating a 3D montage model generation unit according to an embodiment.

Referring to FIG. 6, in 601, the 3D montage model generation unit may combine a 3D unique face model with various expressions using a 3D face expression model. That is, the 3D montage model generation unit may generate various expressions by modifying a shape of the 3D face expression model.

In 602, the 3D montage model generation unit may combine the 3D unique face model with decoration models likely to be used for disguise, for example, a mustache, a beard, a hair, glasses, a hat, a cap, accessories, and the like.

In 603, the 3D montage model generation unit may generate a 3D montage model using a combination of the expression models and the decoration models that are probabilistically likely to be used. The 3D montage model generation unit may generate a probabilistically high 3D montage model using various expression models and various decoration models, based on statistical information relating to an appearance that a suspect is the most likely to disguise himself or herself.

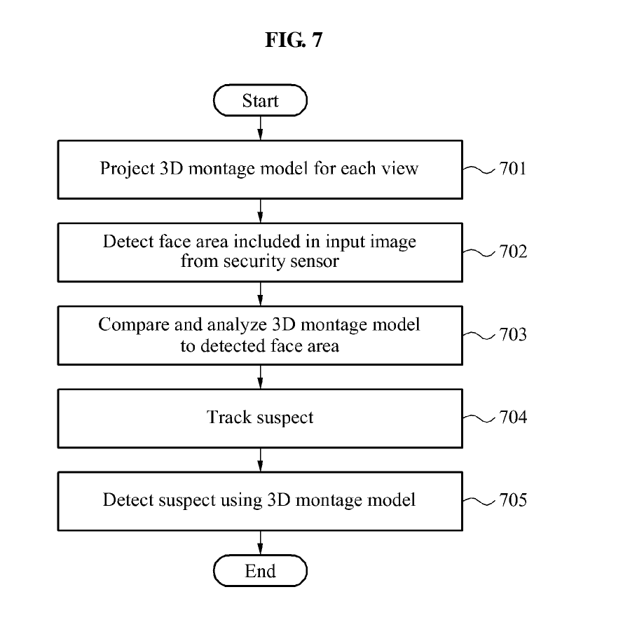

FIG. 7 is a diagram illustrating a montage image generation unit according to an embodiment.

Referring to FIG. 7, in 701, the montage image generation unit may generate a montage image by projecting a 3D montage model from each view.

In 702, the montage image generation unit may detect a face area included in an input image from a security sensor by real-time processing through matching a motion vector of a moving object to the generated montage image.

In 703, the montage image generation unit may compare and analyze the 3D montage model to the detected face area from the security sensor.

In 704, the montage image generation unit may track a location and a behavior of the suspect in real time using a result of the analysis.

In 705, the montage image generation unit may detect or track the suspect based on the comparison and analysis of the generated montage image to the face area from the security sensor in real time.

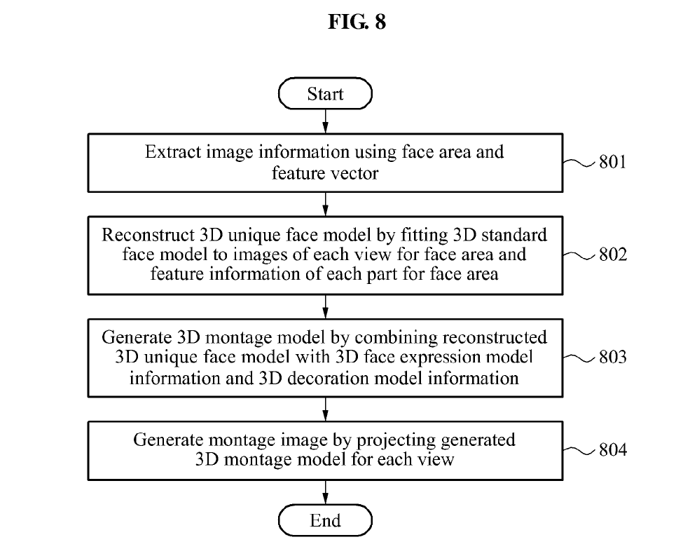

FIG. 8 is a diagram illustrating a method of creating a 3D montage according to an embodiment.

Referring to FIG. 8, in 801, an apparatus for creating a 3D montage may receive an input of images of a face to be detected from different types of sensors. Also, the apparatus for creating a 3D montage may detect a face area using the input face images. Also, the apparatus for creating a 3D montage may generate a statistical feature vector of the face area using a statistical feature of statistical feature information. Also, the apparatus for creating a 3D montage may calculate a face angle, a view, and a scale of the face area based on the statistical feature vector, and may arrange the face images by view. Also, the apparatus for creating a 3D montage may collect face image information of a front view among the arranged face images and may extract texture map image information.

In 802, the apparatus for creating a 3D montage may extract silhouette information of a particular view in the face images of each view and feature information of each part in the face area. The feature information of each part in the face area may correspond to information associated with skeleton locations of each part in the face area and a height, a depth, and a width of each skeleton, based on the silhouette information of the particular view. The apparatus for creating a 3D montage may perform global fitting of the 3D standard face model based on the silhouette information of the particular view and the feature information of each part. The apparatus for creating a 3D montage may set shape information of the globally fitted 3D standard face model and the silhouette information as a guide line, and may perform global fitting of the 3D standard face model based on silhouette information of a different view. In this instance, the apparatus for creating a 3D montage may perform fitting continuously until the shape information of the 3D standard face model and the silhouette information set as the guide line appear.

The apparatus for creating a 3D montage may generate the fitted 3D standard face model including multi-view face image information. Also, the apparatus for creating a 3D montage may reconstruct a 3D unique face model by generating a texture map based on image information for generating the texture map.

In 803, the apparatus for creating a 3D montage may combine the reconstructed 3D unique face model with 3D face expression model information and 3D decoration model information. In this instance, the apparatus for creating a 3D montage may generate various expressions by modifying a shape of a 3D face expression model. The apparatus for creating a 3D montage may combine the reconstructed 3D unique face model with decoration models allowing disguise, for example, a mustache, a beard, a hair, glasses, a hat, a cap, accessories, and the like. That is, the apparatus for creating a 3D montage may generate a probabilistically high 3D montage model using various expression models and various decoration models, based on statistical information relating to an appearance that a suspect is the most likely to disguise himself or herself.

In 804, the apparatus for creating a 3D montage may track a location and a behavior of a suspect in real time by comparing a montage image generated by projecting the 3D montage model from each view, to a face area of an input image from a security sensor. Also, the apparatus for creating a 3D montage may detect or track the suspect by comparing and analyzing the generated montage image to the face area from the security sensor in real time.

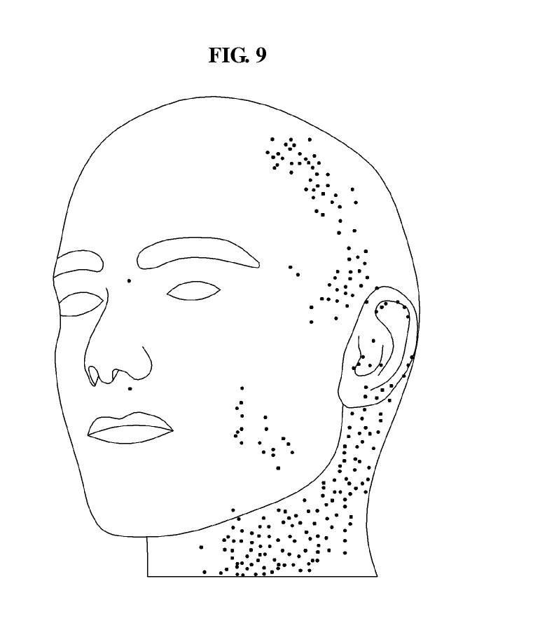

FIG. 9 is a diagram illustrating a standard face mesh model according to an embodiment.

Referring to FIG. 9, the standard face mesh model may be generated by performing global fitting of a selected 3D standard face model corresponding to silhouette information of face images of each view and feature information of each part, to the silhouette information of the face images of each view and the feature information of each part.

That is, the standard face mesh model may be generated by modifying a shape of the selected 3D standard face model based on silhouette information of a multi-view image and statistical feature information. In this instance, the standard face mesh model may be generated without separate geometric calibration.

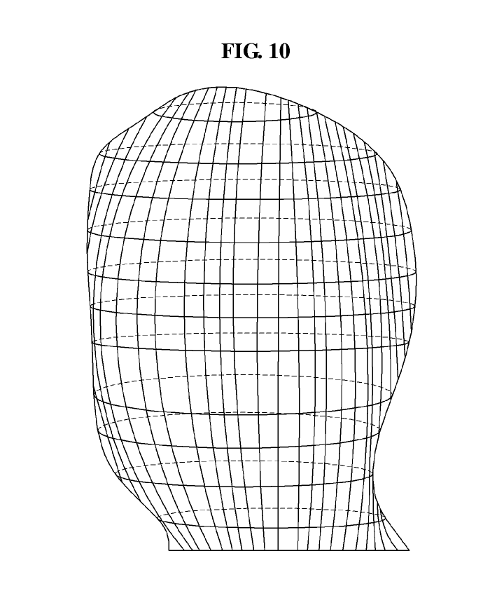

FIG. 10 is a diagram illustrating modeling of a 3D standard face model into a parametrically controllable NURBS curve according to an embodiment.

Referring to FIG. 10, the 3D standard face model may be parametrically controllable. The 3D standard face model may be modeled as a parametrically controllable NURBS curve. To generate a 3D unique face model, the 3D standard face model may be adjusted to match a parameter of the NURBS curve of the 3D standard face model to input silhouette information of a particular view. Also, a 3D standard face mesh model bound to the NURBS curve may be generated by modifying a location of a vertex.

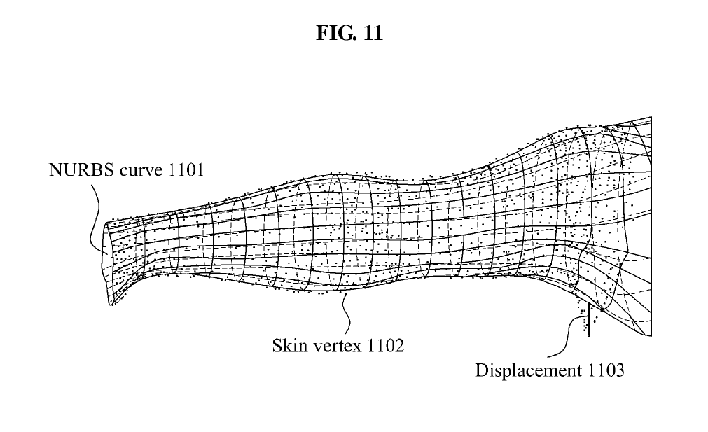

FIG. 11 is a diagram illustrating a process of binding a skin vertex 1102 of a 3D standard mesh model to a NURBS curve 1101 according to an embodiment.

Referring to FIG. 11, the skin vertex 1102 may be bound to the NURBS curve 1101 with a predetermined displacement value 1103. The skin vertex 1102 may have a structure that the skin vertex 1102 is modified to reflect movement at a predetermined ratio as the bound NURBS curve is modified through a parameter.

According to an exemplary embodiment, the method and apparatus for creating a 3D montage may minimize issues in terms of synchronization between the different types of sensors, color consistency, geometric calibration, and the like, by generating a multi-view 3D montage model using images obtained from different types of sensors.

According to an exemplary embodiment, the method and apparatus for creating a 3D montage may compare images obtained by projecting a 3D montage model at various angles and in various sizes to an image from a security sensor, thereby tracking a location and a behavior of a suspect in real time.

The methods described above may be recorded, stored, or fixed in one or more non-transitory computer-readable storage media that includes program instructions to be implemented by a computer to cause a processor to execute or perform the program instructions. The media may also include, alone or in combination with the program instructions, data files, data structures, and the like. The media and program instructions may be those specially designed and constructed, or they may be of the kind well-known and available to those having skill in the computer software arts.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for creating a three-dimensional (3D) montage, the apparatus comprising:
an image information extraction unit to extract image information from a face image to be reconstructed, using a face area based on statistical feature information and a feature vector;
a 3D unique face reconstruction unit to reconstruct a 3D unique face model by fitting a 3D standard face model to face images of each view for the face image and feature information of each part for the face area;
a 3D montage model generation unit to generate a 3D montage model by combining the reconstructed 3D unique face model with 3D face expression model information and 3D decoration model information; and
a montage image generation unit to generate a montage image by projecting the generated 3D montage model from each view.

2. The apparatus of claim 1, wherein the image information extraction unit detects the feature vector of the face area using a statistical feature of the statistical feature information.

3. The apparatus of claim 1, wherein the image information extraction unit arranges the face images by view using at least one of an angle, a view, and a scale of the feature vector.

4. The apparatus of claim 3, wherein the image information extraction unit collects face image information of a front view among the arranged face images, and extracts image information for generating a texture map.

5. The apparatus of claim 1, wherein the 3D unique face reconstruction unit selects the 3D standard face model based on silhouette information of a particular view in the face images of each view and the feature information of each part.

6. The apparatus of claim 1, wherein the 3D unique face reconstruction unit performs global fitting of the 3D standard face model to silhouette information of a particular view in the face images of each view and the feature information of each part.

7. The apparatus of claim 5, wherein the 3D unique face reconstruction unit modifies a shape of the 3D standard face model by performing global fitting of the fitted 3D standard face model to the silhouette information of the images of each view and the feature information of each part, using the fitted 3D standard face model and the silhouette information as a guide line.

8. The apparatus of claim 6, wherein the 3D unique face reconstruction unit reconstructs the 3D unique face model corresponding to the modified 3D standard face model using a texture map generated based on the image information.

9. The apparatus of claim 1, wherein the 3D montage generation unit generates the 3D montage model by combining the 3D unique face model with a face expression model and a decoration model that are probabilistically likely to be used for disguise.

10. A method of creating a three-dimensional (3D) montage, the method comprising:
extracting image information from a face image to be reconstructed, using a face area based on statistical feature information and a feature vector;
reconstructing a 3D unique face model by fitting a 3D standard face model to face images of each view for the face image and feature information of each part for the face area;
generating a 3D montage model by combining the reconstructed 3D unique face model with 3D face expression model information and 3D decoration model information; and
generating a montage image by projecting the generated 3D montage model from each view.

11. The method of claim 10, wherein the extracting of the image information comprises detecting the feature vector of the face area using a statistical feature of the statistical feature information.

12. The method of claim 10, wherein the extracting of the image information comprises arranging the face images by view using at least one of an angle, a view, and a scale of the feature vector.

13. The method of claim 12, wherein the extracting of the image information comprises collecting face image information of a front view among the arranged face images and extracting image information for generating a texture map.

14. The method of claim 10, wherein the reconstructing of the 3D unique face model comprises selecting the 3D standard face model based on silhouette information of a particular view in the face images of each view and the feature information of each part.

15. The method of claim 10, wherein the reconstructing of the 3D unique face model comprises performing global fitting of the 3D standard face model to silhouette information of a particular view in the face images of each view and the feature information of each part.

16. The method of claim 15, wherein the reconstructing of the 3D unique face model comprises modifying a shape of the 3D standard face model, by performing global fitting of the fitted 3D standard face model to silhouette information of the images of each view and the feature information of each part, using the fitted 3D standard face model and the silhouette information as a guide line.

17. The method of claim 16, wherein the reconstructing of the 3D unique face model comprises reconstructing the 3D unique face model corresponding to the modified 3D standard face model using a texture map generated based on the image information.

18. The method of claim 10, wherein the generating of the 3D montage image comprises generating the 3D montage model by combining the 3D unique face model with a face expression model and a decoration model that are probabilistically likely to be used for disguise.
